(19) United States
(12) Patent Application Publication
(10) Pub. No.: US 2007/0131762 A1
(43) Pub. Date: Jun. 14, 2007

(54) Process and device for dispensing doses of powdered products, particularly for a beverage dispenser

(76) Inventor: Max Dumont, Brive La Gaillarde (FR)

Correspondence Address: YOUNG & THOMPSON, 745 SOUTH 23RD STREET, 2ND FLOOR, ARLINGTON, VA, 22202, US

(21) Appl. No.: 11/603,120

(22) Filed: Nov. 22, 2006

(30) Foreign Application Priority Data
Nov. 23, 2005 (FR) 05 53560

(51) Int. Cl. G06F 7/08

(52) U.S. Cl. 235/381

(57) ABSTRACT

The object of the invention is a process for dispensing doses of powdered products, particularly for the production of hot and cold beverages, from at least one carton containing said products and provided with motorized dosage and dispensing means secured to said carton, these cartons being disposed in a dispenser, characterized by the following series of steps: placing the carton in the dispenser with connection between the dosage and dispensing means and the dispenser, automatically recognizing the carton by the dispenser and hence the product contained in this carton, adjusting the number of doses necessary as a function of the powdered product contained in said thus-recognized carton, dispensing these doses. The invention also covers the device for practicing the process and the associated carton.

The present invention relates to a process and a device for dispensing doses of powdered products, particularly for the production of hot and cold beverages.

These processes and devices are adapted as a function of the products.

There are known distributors of beverages which use cartons of powdered products with dispensing means for this powder, into receptacles generally for single use. Hot or cold water is also dispensed as a function of the products so as to obtain the selected hot or cold beverage.

There are thus known dispensers which permit, thanks to a battery of cartons containing dehydrated products in the form of powder, cold water and means to heat this water to obtain coffee-based beverages, flavored fruit beverages, soups, milk beverages, etc. . . . . If such an arrangement is known, it is also known that several problems arise that have not been solved, as to which the present invention provides solutions.

A problem connected with the distribution of these products relates to the cartons themselves. These cartons are made of material such as cardboard and are provided with dosage means and associated means to deliver said dose into a container.

These dosage means are of identical capacity for each carton. However, the dosage for a soup, a flavored beverage or a milk-based beverage is not identical and certain products require one dose, two doses or three doses, to give an example.

It is thus necessary that the user read the instructions carefully and act several times on the dosage means. In the contrary case, the beverage is not satisfactory from the point of view of taste and risks losing the customer for the future in addition to the unsuitability for immediate consumption of a beverage which is less acceptable or worse.

So that consumers and above all the operator charged with reloading the dispenser with know the remaining content of the carton, there is provided a visualization window of transparent material.

Nevertheless, it must also in this case be calculated whether the remaining level is identical, the same number of delivered beverages being unsuitable according to the type of beverage.

These cartons are for single use and must be replaced once empty by new cartons from the supplier. Several reasons require such an arrangement, because it is necessary that the product be suitable and when the users wish to replace the empty cartons with commercial products thinking they are analogous, the dispenser rapidly breaks down.

Thus, the dryness is not good and the doser clogs, the granulometry, the composition of the product relative to the programmed dosage, are unsuitable.

Above all, conditions of hygiene are difficult to observe during such observations.

If it is desired to motorize the dispensing, the dispensing device becomes difficult to control.

Thus, if there is provided a mechanism which actuates the necessary number of times the dosage/dispensing means, it is absolutely necessary that the corresponding carton requires this number of doses. Any inversion of the cartons and of the number of doses will give rise to major defects in the quality of the dispensed beverages.

Moreover, this loses the flexibility of a dispenser comprising a battery of cartons.

As to manually modifying the number of doses of the mechanism with each change of carton, this is unrealistic for an industrial product used in a large number at very numerous sites. The errors, the requirements for maintenance, are not compatible and such dispensers destined for failure.

Moreover, the cartons containing powdered products sensitive to humidity, this being inherent in any powder, the content of these cartons must be used within a given time, failing which clogging can take place, giving rise to malfunctions.

At present, the limit date for consumption is indicated on such cartons but it is impossible to know the date of use of a carton at the time of observing a breakdown of the dispenser, and hence it is impossible to know whether the carton has been open for a time greater than that for which it is destined. The duration of closed conservation of a powdered product is thus very much greater than the duration during which the product must be consumed once the carton is opened.

There is known U.S. patent 2003/0006281, which discloses a device, generally speaking, having containers provided with “intelligent” labels, such as to be able to control both the production in the factory and the use by the consumer when a special machine is used for the production of the final product.

In the present invention, the situation is different in the sense that there exists no special machine for preparation. The object is to provide a dosage as a function of the product which is known, in a container provided with its own dosage and dispensing means. It thus is not a matter of actuating these dosage and dispensing means, the dispensing apparatus never having contact with the product as in the prior art.

Once the product is consumed or has expired, the assembly of the container with its dosage/dispensing means is removed from the apparatus and discarded because its contents are for single usage.

This has a number of advantages from the point of view of hygiene, as will be explained hereafter in combination with these advantages with those connected to the date of consumption associated with the products themselves.

The process for dispensing and the associated device according to the present invention seek to overcome the drawbacks and the complexity of the embodiments of the prior art, and a preferred mode of production will now be described in detail, which although non-limiting is explicative and this description is shown by a series of drawings in which the different figures represent:

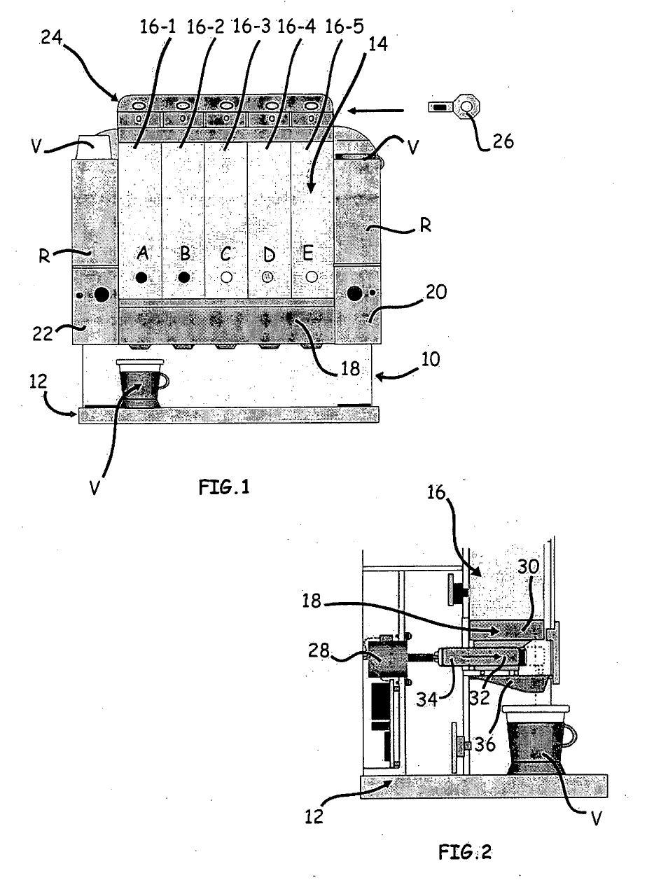

FIG. 1: a view of a dispenser according to the invention with five cartons,

FIG. 2: a schematic view in cross-section to permit visualization of the dosage/dispensing means,

FIG. 3: a synoptic view of the operation of the dosage/dispensing means,

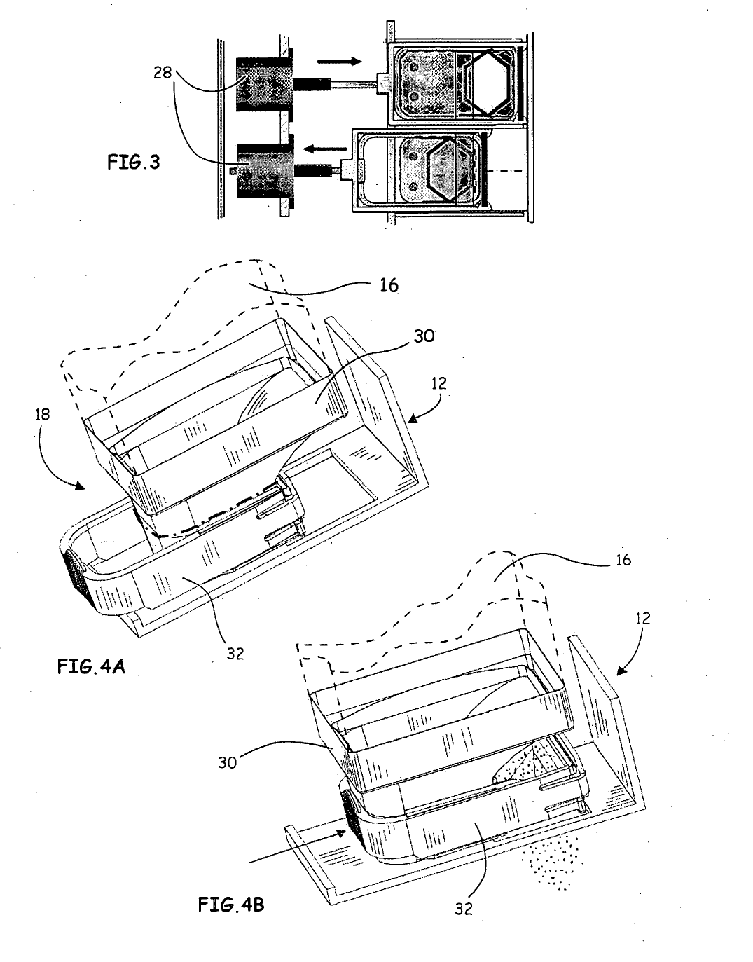

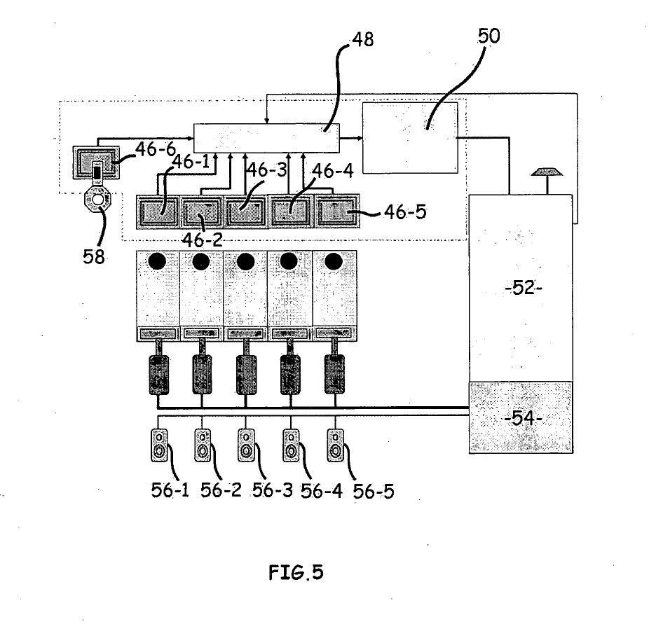

FIGS. 4A and 4B: a view of details of the dosage/dispensing means in two operative positions,

FIG. 5: a view of the means for recognizing and controlling the cartons of the dispenser according to the process of the invention,

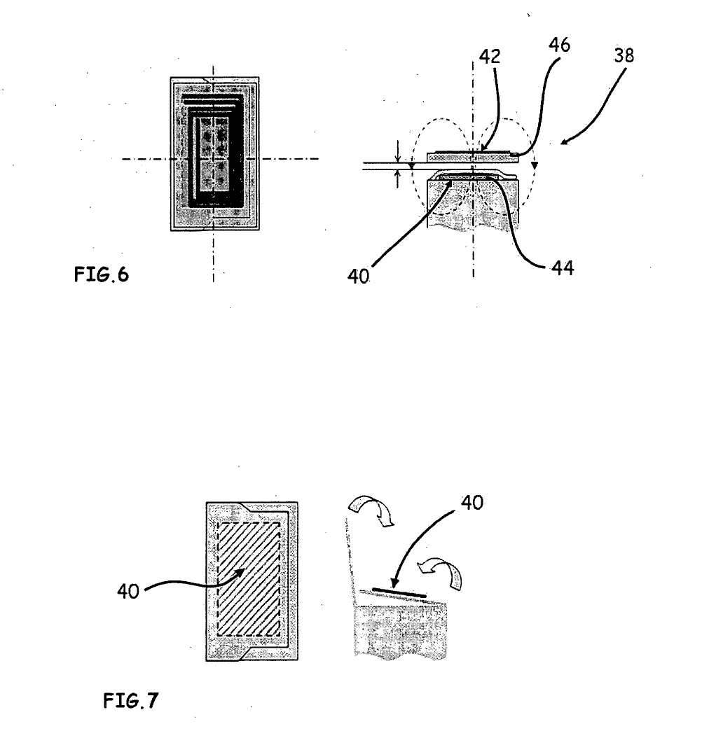

FIG. 6: a detailed view of the coupling means, and

FIG. 7: a schematic view of the positioning of a portion of the coupling means.

In FIG. 1, there is shown a dispenser 10 comprising a frame 12 supporting a battery 14 of cartons 16-1 to 16-5 containing powdered products to be distributed, including means 18 to dose and deliver these products into a container V, a reserve R of containers V, means 20 to deliver hot water and means 22 to deliver cold water.

The dispenser comprises in known manner a unit 24 for controlling the dispenser, and payment means 26.

As shown in FIGS. 2 and 3, the dispenser according to the present invention comprises actuators 28 for the means 18 of the cartons 16 to dose and dispense the products.

The means 18 to dispense and dose the powder product are secured to the carton 16. These means 18 comprise a hopper 30 secured to the carton and a dispensing drawer 32 itself connected to a stirrup 34, said stirrup 34 ensuring easily disassembleable connection, particularly a connection by encasement, of said dosage and dispensing means 18 with the actuators 28 of the dispenser 10.

This dispensing drawer 32 can have two positions, seen particularly in FIG. 3, so as to collect a dose in the first position, shown in FIG. 4A, below the carton by the phenomenon of gravity to which the powder is subject, and to dispense in the second position, shown in FIG. 4B, the dose thus collected after a translatory movement.

The movements of this dispensing drawer 32 are caused by an associated actuator 28, by means of the stirrup 34.

The actuators comprise generally speaking a motor and can be of any type, which is to say with cam drive, piston drive, with an endless screw and a pinion or else with an electromagnet to cite but certain examples. The resilient return means of the dispensing drawer can be simply an elastic band, shown schematically in broken lines in FIG. 4A, in this instance a band of elastomeric material.

The hopper 30, secured to the carton 16, comprises an upper portion of a cross-section substantially identical to that of the carton 16 and a lower portion whose cross-section decreases to be reduced to that of the dispensing drawer 32.

The drawer 32 comprises a given volume corresponding to one dose of powdered product. The internal shape is suitable to permit flow of the powder, to avoid any phenomenon of grinching, to limit the retention zones, and to scrape off the regions of accumulation of powder.

In the first position, the drawer 32 is placed in line with the hopper so as to receive the powder which is located in the carton and which falls by gravity. In the second position, the drawer is translated by the actuators 28 and is located in line with the container V.

It is to be noted that the assembly of the dosing and dispensing means, namely the dispensing drawer 32, the hopper 30 and if desired resilient return means, are secured to each carton and are thus connected to the lifetime of a carton. These dispensing means must be simple and reliable and low cost.

A gutter 36, disposed below the stirrup, permits channeling in an even more certain fashion the fall of the powder into the container V, as will be explained hereafter.

The arrangement of this dispenser is completed by a unit 24 for controlling the dispenser, particularly controlling the dosage and dispensing means and by payment means 26.

This control means 24 comprises means 38 for coupling between each carton and said unit.

These coupling means 38 comprise identification means 40 carried by the carton and reading means 42 carried by the frame. More precisely, the identification means 40 comprise a label 44-1 to 44-5 so-called RFID (Radio Frequency Identification) with a memory and an antenna which carries in its memory system information relative to the carton. Thus, there can be found as information the nature of the product contained within the carton, the number of doses necessary to produce a beverage of suitable concentration for a container V of given volume, the number of beverages which can be obtained with one carton, the limit date for consumption.

The identification means 40, in this instance the RFID label, is preferably arranged as shown in FIG. 7, on the first flap, so as to be located below the second flap after filling and closing of the carton. In the case of the RFID label, the thickness of a flap does not impede the operation of the antenna and permits reading of the information of the label, without it being visible.

This reading is ensured by a base 46-1 to 46-5 provided with an antenna, one antenna per label when there are RFID labels. These bases 46 are carried by the frame such that the antenna will be located in line with the top of the carton, in facing relation with the carton when the carton is disposed as shown in FIG. 6.

The control unit moreover comprises a switch 48 for antennas, because there are five antennas in the illustrated embodiment, one RFID coupler 50 for reading/writing and a microcontroller 52 for all the data. This microcontroller also excites a power circuit 54 for its supply of each of the motorizations secured to the frame of each of the dosing and distribution means for the powder of each of the cartons.

So as to provide visual information, displays 56-1 to 56-5, for example two-color diode displays, are associated with the cartons. These displays are also controlled by the microcontroller 52.

The operation of the coupling means 38 is known per se and consists in emitting a magnetic field and in transferring written and/or read information from the label to the base, these data being controlled by the microcontroller.

The distance between the antennas of the label and the base is very short, several millimeters, such that information exchanged by the coupling means associated with one carton does not interfere with the information exchanged by a coupling means associated with another carton. The exchanges thus remain selective.

Thus during use of a carton, it is possible to generate a date in which the carton was used.

Moreover, when there is a carton of a given product requiring three doses for one preparation, this information is associated with the carton, and hence it suffices to place the carton such that the dosage and distribution means at three times by means of the associated actuator, thereby three times operating the dispensing drawer when a consumer uses the dispenser.

Similarly, the displays will remain with the green diode illuminated as long as the number of doses remaining in the carton is greater than the number of doses required to produce the last beverage. When the content of the carton is less than the number of doses necessary to provide a beverage, the green diode extinguishes and the red diode lights up, for example.

The red diode can also be lit instead of and in place of the green dioide, even if there still remains numerous doses, but when the duration from the opening is greater than that which is provided, this can give rise to malfunction of the carton in question by degradation of the powder. This predetermined duration is particularly variable as a function of the powder contained and the lifetime must be counted from the time the carton is placed in service.

Such a dispenser is provided with payment means in most cases. In the illustrated embodiment, these payment means comprise again a base 46-6 connected to the microcontroller through the antenna switch 48 and the coupler 50.

The associated payment means is a rechargeable RFID key 58 comprising payment units and of which each customer carries one.

This key 58, approached in line with the antenna of the base 46-6, permits triggering the operation of the dispenser according to the selected beverage ordered by the customer, through the microcontroller (52).

The customer thus obtains the beverage in the form of powder but dosed as a function of the type of beverage and of the volume of the container. It suffices that he then adds the necessary water, hot or cold as needed.

The water is delivered to the customer when this customer acts manually on a button, which permits if desired providing a more or less concentrated beverage accordingly as the customer proceeds to fill his container V more or less completely. Information can be indicated on the container. It will be noted that there is no contact of the powder with the dispenser, which is particularly hygienic.

If the carton is empty, the display indicates this with illumination of a red LED, for example, and the customer will not be able to make this choice. If he tried nevertheless, the doser will not function because the microcontroller sends no order, having determined that there remains insufficient powder to constitute a beverage. Similarly, the RFID key which may be present is not debited.

Thanks to the process and device according to the present invention, it is possible to connect a price with the product because each carton is recognized and identified. The price of each beverage is thus computed and deducted from the sum credited to the RFID key of the customer instead of providing but a single charge as was necessary in the case of devices of the prior art.

The carton provided with its coupling means cannot be raised for refilling with other products, because as soon as the flap is opened, the RFID label is degraded and prevents the reuse of the carton as a container for the device. This avoids any malfunction of the dispenser but also any risk of contamination by unsuitable products.

If there were nevertheless a refilling of the carton with a powder, for example on the side, the carton would nevertheless not function because the number of deliverable doses is in any event exceeded.

Similarly, if a carton exceeds the time limit of use after opening, the customer cannot obtain beverages from this carton and its contents, even if there remained ample powder.

It will also be understood that, thanks to the coupling means, it is possible to position in a dispenser no matter what carton in no matter what position because the carton is recognized upon emplacement and the associated information permits perfect operation adapted to the doser integrated into the carton.

This is very advantageous for the proper maintenance and reloading of the dispenser. As a function of the demand by the customers, the carton initially with coffee can be replaced by a tea carton or cappuccino carton, without other programming or modification, etc.

The carton carries all the information for the customers and this information is on the one hand common to all the carton and relates to the use but on the other hand is specific to the product contained in the carton, which permits positioning in any place in the dispenser a given carton.

The dosage and dispensing means are identical from one carton to the other, which facilitates the production of the carton and standardizes the insertion in the dispenser. As these dosage and dispensing means are secured to the carton, the dispenser necessarily benefits from new dosage and dispensing means with each new carton, which avoids the problems of wear, deposits, and clogging in the corner portions which would be inherent to dosage and dispensing means attached to the dispenser.

1. Process for dispensing doses of powdered products, particularly for the production of hot and cold beverages from at least one carton containing said products and provided with motorized dosage and dispensing means secured to said carton, these cartons being disposed in a dispenser, characterized by the series of the following steps:
placing the carton in the dispenser with connection between the dosage and dispensing means and the dispenser,
automatically recognizing the carton by the dispenser and hence the product contained in this carton,
adjusting the number of doses necessary as a function of the powdered product contained in said thus-recognized carton,
distribution of these doses.

2. Process for dispensing according to claim 1, characterized in that the number of beverages initially produceable with one carton is memorized and in that the number of beverages produced is counted down to determine before each dosage/dispensing the condition of filling of the carton.

3. Process for dispensing according to claim 1, characterized in that the date of placing in use each carton is automatically memorized during its emplacement and in that the limit date of use for this carton is computed by adding to this starting date a predetermined lifetime of maximum service for the carton thus recognized, which lifetime is a function of the product contained in the carton.

4. Device for dispensing doses of powdered products, particularly for the production of hot and cold beverages, permitting the use of the process according to claim 1, characterized in that it comprises a frame (12) supporting at least one carton (16-1 to 16-5) containing a powdered product to be dispensed, means (18) to dose and deliver the products into a container V, a unit (24) for controlling the distribution integrating means (38) for coupling between each carton (16) and said control unit (24).

5. Device for dispensing according to claim 4, characterized in that the coupling means (38) comprise identification means (40) carried by each carton (14) and reading means (42) carried by the frame (12).

6. Device for dispensing according to claim 5, characterized in that the identification means (40) comprise a label (44-1 to 44-5) called RFID (Radio Frequency Identification) with an antenna and a memory which carries information relative to the carton and the reading means (42) each comprise a base (46-1 to 46-5) provided with an antenna located in line with the drop of the carton (14) in facing relation.

7. Device for dispensing according to claim 4, characterized in that the control means comprise an antenna switch (48), a couple (50) for the reading/writing and a microcontroller (52) for all the information.

8. Device for dispensing according to claim 6, characterized in that the memorized information comprises the nature of the product contained in the carton (16), the number of doses necessary to produce a beverage of a concentration suitable to a container V of a given volume, the number of beverages to be produced with this carton, and the limit date of consumption.

9. Device for dispensing according to claim 4, characterized in that it comprises payment means (26).

10. Device for dispensing according to claim 8, characterized in that the payment means (26) comprise for each customer a rechargeable RFID key (58) comprising payment units and a base (46-6) with an antenna secured to the frame, connected to the microcontroller (52).

11. Device for dispensing according to claim 4, characterized in that the means (18) to dose and deliver the powder products are secured to each carton (16) and comprise a hopper (30) secured to said carton and a dispensing drawer (32) itself connected to a stirrup (34), this dispensing drawer (32) being adapted to assume two positions, so as to collect a dose in the first position below the carton and a second position in which the dose thus collected is dispensed, this dispensing drawer (32) being actuated by an associated actuator (28) secured to the frame (12).

12. Device for dispensing according to claim 4, characterized in that the stirrup (34) ensures a connection between said dosing and dispensing means (18) and the actuators (28) secured to the dispensing device.

13. Carton for the dispenser according to claim 4, characterized in that the identification means (40) carried by each carton (14) is positioned below one of the flaps of said carton.

14. Process for dispensing according to claim 2, characterized in that the date of placing in use each carton is automatically memorized during its emplacement and in that the limit date of use for this carton is computed by adding to this starting date a predetermined lifetime of maximum service for the carton thus recognized, which lifetime is a function of the product contained in the carton.

15. Device for dispensing according to claim 5, characterized in that the control means comprise an antenna switch (48), a couple (50) for the reading/writing and a microcontroller (52) for all the information.

16. Device for dispensing according to claim 6, characterized in that the control means comprise an antenna switch (48), a couple (50) for the reading/writing and a microcontroller (52) for all the information.

17. Device for dispensing according to claim 5, characterized in that it comprises payment means (26).

18. Device for dispensing according to claim 6, characterized in that it comprises payment means (26).

19. Device for dispensing according to claim 7, characterized in that it comprises payment means (26).

20. Device for dispensing according to claim 5, characterized in that the means (18) to dose and deliver the powder products are secured to each carton (16) and comprise a hopper (30) secured to said carton and a dispensing drawer (32) itself connected to a stirrup (34), this dispensing drawer (32) being adapted to assume two positions, so as to collect a dose in the first position below the carton and a second position in which the dose thus collected is dispensed, this dispensing drawer (32) being actuated by an associated actuator (28) secured to the frame (12).
